(19) United States
(12) Patent Application Publication
(10) Pub. No.: US 2008/0103910 A1
(43) Pub. Date: May 1, 2008

(54) Method for motivating behavioral changes through rewards

(76) Inventor: Will Harris Gardenswartz, Laguna Beach, CA (US)

Correspondence Address: PATENT LAW & VENTURE GROUP, 2424 S.E. BRISTOL, SUITE 300, NEWPORT BEACH, CA, 92660, US

(21) Appl. No.: 11/975,857

(22) Filed: Oct. 22, 2007

Related U.S. Application Data
(60) Provisional application No. 60/854,901, filed on Oct. 26, 2006.

(51) Int. Cl. G06Q 30/00; G06F 17/40; G06F 19/00

(52) U.S. Cl. 705/14

(57) ABSTRACT

A method of motivating a person, through reward benefits, to participate in activities leading to a selected behavior wherein a benefactor establishes and defines a system of required behaviors for a beneficiary. The required behaviors earn the reward benefits, prior to a deadline for compliance. A program manager monitors the behaviors through transactional reports generated by participating third party vendors, compares the behaviors to the requirements, and distributes portions of the reward benefits to the beneficiary in accordance with the terms of a contract. The program ends when either the benefit account is depleted or the deadline is reached. Thus, the present method provides motivation for changing the beneficiary's lifestyle and releases a stream of rewards when lifestyle goals are being met.

### CROSS-REFERENCE TO RELATED APPLICATIONS

This application is a non-provisional application describing the same invention as an active provisional application Ser. No. 60/854,901, filed on Oct. 26, 2006, and being filed within one year, hereby claims date priority therefrom.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to training methods and more particularly to a system for rewarding an individual's behavior and changes in behavior.

2. Description of Related Art Including Information Disclosed Under 37 CFR 1.97 and 1.98

Brown el al, U.S. Pat. No. 5,879,163, discloses an automated system and method providing customized health education to an individual at a remote terminal to induce a modification in a health-related behavior of the individual.

Beach et al, U.S. Pat. No. 5,892,827, discloses a system for generating authorization codes, such as personal identification numbers, at the point of distribution of certificates of value on which the authorization codes are to be printed or otherwise encoded.

Klapka, U.S. Pat. No. 5,915,007, discloses a method and system for using a frequent shopper card as a phone calling card including (a) issuing a transfer certificate with a predetermined phone time and having a first personal identification number, at a terminal; and (b) adding the predetermined phone time to an account, associated with the frequent shopper card having a second personal identification number, based on the first personal identification number, at a server.

Brown, U.S. Pat. No. 5,933,136, discloses a system and method for controlling patient access to an entertainment program to encourage a patient to comply with a treatment plan.

Brown, U.S. Pat. No. 5,960,403, discloses a system and method for remotely monitoring a patient and for training the patient to comply with a treatment plan for a health condition. A patient computing device collects data relating to the patient's health condition and transmits the data to a clinician computer via a communication network. The data is analyzed in the clinician computer to determine an educational need of the patient for treating the health condition. An educational program corresponding to the patient's educational need is selected and a pointer to the educational program is embedded in an electronic message to the patient. The educational program is started on the patient computing device by selecting the embedded pointer in the electronic message. As the patient works with the educational program, new data relating to the patient's health condition is collected in the patient computing device and transmitted to the clinician computer for analysis. With this continuous feedback loop between the patient and clinician, the clinician is able to monitor the patient's progress and effectively train the patient to comply with the treatment plan.

Jermyn, U.S. Pat. No. 6,026,370, discloses a technique for customizing mailed purchase incentives for selected consumer households, based on a detailed purchasing history of the consumers. Purchase transactions of many consumers, generally in different stores, are accumulated in a purchase history database over a long period of time and then used to generate customized incentive offers for selected consumers. For a selected product category, usually related to a promotional theme, the purchase history database is scanned to select consumers who have made purchases in the same product area as the selected product category. Then each selected consumer's purchase transactions are analyzed to determine a profile for the consumer, such as loyal to the promoted brand, loyal to a competitive brand, or new to the selected product category, although a purchaser of related products. The consumer profile is then used to customize a purchase incentive package generated for each consumer household.

Byerly et al, U.S. Pat. No. 6,067,524, discloses a method and system for generating advisory messages to pharmacy patients includes appending patient-specific information to a data record containing normally transmitted information. The data record is transmitted between a third party computer and a pharmacy computer during a pharmacy transaction. The data record transmitted to the pharmacy computer is captured by an advisory computer as the data record is received by the pharmacy computer or after the data record is transmitted to the pharmacy computer, and the patient-specific information is extracted from the captured data record. The advisory computer generates an advisory message based on the extracted patient-specific information, and it transmits the generated advisory message to a pharmacy printer.

Quy, U.S. Pat. No. 6,144,837, discloses a method and apparatus for interactively monitoring a physiological condition and for interactively providing health-related information.

Brown, U.S. Pat. No. 6,151,586, discloses a computerized reward system which encourages an individual's participation in a health management system and includes a script generating means for generating a health management script, a script assignment means for assigning a health management script to the individual, a monitoring means for collecting data on the individual's compliance, a memory means for storing the compliance data, an evaluation means for comparing the compliance data to evaluation criteria to determine if the patient is compliant, and a reward to be given to the compliant individual. The individual's compliance is evaluated by his or her answers to the health management script. Each health management script program can be custom made for each individual. The different monitoring means possible which the individual can use include a remotely programmable apparatus, an interactive telephone call, and a multimedia processor. The rewards include a coupon and an electronic reward credited to the individual's data card or personal account at a store.

Brown, U.S. Pat. No. 6,161,095, discloses a method and system for interaction with a community of individuals, relating to compliance with a treatment regimen. Individuals interact with a protocol or intelligent message to provide assistance in all aspects of treatment regimen compliance, data collection, supply, review and modification.

Brown, U.S. Pat. No. 6,168,563, discloses a system and method that enables a health care provider to monitor and manage a health condition of a patient. The system includes a health care provider apparatus operated by a health care provider and a remotely programmable patient apparatus that is operated by a patient. The health care provider develops a script program using the health care provider apparatus and then sends the script program to a remotely programmable patient apparatus through a communication network such as the World Wide Web. The script program is a computer-executable patient protocol that provides information to the patient about the patient's health condition and that interactively monitors the patient health condition by asking the patient questions and by receiving answers to those questions. The answers to these health related questions are then forwarded as patient data from the remotely programmable patient apparatus to the health care provider apparatus through the communication network.

Brown, U.S. Pat. No. 6,246,992, discloses a system and method for monitoring a group of patients having a chronic disease or ongoing health condition. The method includes the step of collecting from each patient a corresponding set of measurements of a control parameter of the health condition. Each set of measurements has a collection date. A control value is calculated for each patient from the corresponding set of measurements. The method further includes the steps of generating and displaying a group overview chart having one data point for each patient. Each data point indicates the control value calculated for the corresponding patient and a time period which has elapsed since the collection date of the patient's corresponding set of measurements. The method includes the additional steps of selecting from the group overview chart at least one of the patients represented thereon and transmitting supervisory instructions to the at least one selected patient.

Giuliani, U.S. Pat. No. 6,282,516, discloses a system, process and computer readable medium for distributing purchasing incentives throughout departments of a retail store including an incentive processor including a network controller and a database for storing shopping histories of consumers associated with respective unique consumer identifiers; a plurality of incentive distributors located throughout the departments of the retail store, each incentive distributor of the plurality of incentive distributors having a unique address, and including, a processor, a printing device, a network interface device, and one of a card reader device and a scanner device; and a network, coupling the network controller to network interface devices of the plurality of incentive distributors, for effecting two-way communications between the incentive processor and the plurality of incentive distributors.

Deaton et al, U.S. Pat. No. 6,351,735, discloses a check transaction processing, database building and marketing method and system utilizing automatic check reading.

Day et al, U.S. Pat. No. 6,484,146, discloses a system for offering targeted discounts to customers and collecting purchasing behavior data.

Laor, U.S. Pat. No. 6,584,448, discloses a method of and system for distributing and redeeming electronic coupons.

Deaton et al, U.S. Pat. No. 6,684,195, discloses a system and method for customer promotion. A terminal enters a customer's identification code, along with customer transaction data, at the point-of-sale. A memory stores a database of previously entered customer identification codes and transactions data. Circuitry is provided for generating a signal representative of a customer's shopping history, wherein incentive coupons may be issued to customers in dependence upon the signal.

O'Brien et al, U.S. Pat. No. 6,795,809, discloses a system for automatically distributing discount coupons or certificates in a retail store, conditioned on a pre-selected combination of present and past shopping behavior of a customer whose order is being processed at a checkout stand. Generation of a printable discount coupon can be based on any desired combination of customer-supplied data, obtained from a customer identification data base, past shopping activity, derived from data gathered during previous customer visits to the store, and present shopping activity, as evidenced by items identified in the current customer order. Collection of data pertaining to past behavior of customers is facilitated by filtering all sales transaction data at the point of sale. If all of the pre-selected conditions for generation of a coupon are satisfied, the coupon is generated and printed at the checkout stand.

Austin, U.S. Pat. No. 6,865,544, discloses a method of administering a rebate system.

Scroggie et al, U.S. Pat. No. 6,885,994, discloses a system and method for providing shopping aids and incentives to customers through a computer network.

Giuliani et al, U.S. Pat. No. 7,058,591, discloses a technique for customizing purchase incentives, such as discount coupons and the like, based on whether a consumer buys a promoted item or a competitive item, and on the price of the promoted item relative to the competitive item. The invention identifies promoted or competitive products in a consumer's order, and selects an incentive that is appropriate for the price differential between the promoted and competitive items, and for the purchase choice already made between the promoted and competitive items. a different incentive is provided for the different pricing and choice combinations, in an effort to maximize sales for the promoted item, and the different incentives are stored in an incentive matrix accessed by product purchased and by consumer profile as determined from whether the consumer bought the more expensive item, the less expensive item, or one of two equally priced items.

Upromise, Inc. (www.upromise.com) is an American corporation that provides marketing services and incentives to establish brand loyalty in college students and their families. Upromise actively solicits college students and their families to join its program through direct mailings, tabling at colleges, fliers, and advertisements in periodicals. The free program earns members rebates on purchases of select brands at participating retail stores and services. The rebates can be applied toward education savings accounts or directly to student loans.

The related art described above discloses methods and systems for monitoring and motivating individuals based on a wide range of criteria. However, the prior art fails to disclose a method for motivating behavioral changes by measuring actual performance and using such as a basis for a stream of rewards to maintain motivation. In the present invention method, a server stores individual reward accounts containing defined programs based on contractual terms and conditions. Linking product and service vendors enables automatic logging of quantifiable user behavior to automatically monitor and measure user compliance over a defined time period. Rewards are provided in a recurring format to the subject based on their compliance. The present disclosure distinguishes over the prior art providing heretofore unknown advantages as described in the following summary.

### BRIEF SUMMARY OF THE INVENTION

This disclosure teaches certain benefits in use which give rise to the objectives described below.

Lifestyle changes are difficult to make, usually requiring extended time periods and dogged personal dedication. For example, weight lost in a diet program is most often regained, exercise and workout programs almost never become routine, and obesity and poor physical fitness are common even for those earnestly wishing to avoid or ameliorate such problems. Consider the difficulties that arise when one individual, a father for instance, wishes to motivate another, the father's son, for example. The father may have no time to manage a motivational program with a son who is living on his own, perhaps in college. The son is not motivated to take fatherly advice since he believes he knows what is best for himself. Even if the father promises a reward if the son does well in his studies, such a promise may not motivate the son since there is no present reward, only a distant promise. This type of problem is a common and enduring one. The presently described method is a unique solution to this problem because it overcomes the problem of program management and of distant rewards which may seem unattainable or too far in the future to be considered with respect to present lifestyle activities.

The present method rewards behavioral changes over time with small rewards for small gains on a continuing bases. It operates to release a modest stream of rewards when selected behaviors are performed by a subject. In the present context, the total pool made available for rewarding changed behavior is referred to by the term “benefit” and this includes individual small releases from a “benefit account.” The method allows friends and family to offer the kind of consistent support needed to build lasting lifestyle changes. In this method, the beneficiary of the benefit is referred to by the term “beneficiary,” the beneficiary being an individual or individuals or other entity, that receives the reward benefits for demonstrating desired changes in selected behaviors. Those that provide the reward benefit are referred to as “benefactors.” Therefore, the beneficiary receives benefit portions from the benefit account provided by the benefactors when the beneficiary's behavior is in accordance with a behavior pattern selected by the benefactor or by the benefactor and the beneficiary together; or, by the beneficiary with the ascent and approval of the benefactor.

In the present method the benefactor has no trouble monitoring the behavior of the beneficiary since that is done by a “program manager”. Further, the benefactor is relived of the role of distributing the benefit to the beneficiary, which role generate resentment between beneficiary and benefactor. Finally, the beneficiary has no trouble in understanding what behavioral changes are required to maintain the benefit stream. The present method provides a simple and easily understood situation to all parties because it is well defined and communicated by the program manager. It further enables friends, family, and others to offer the kind of consistent support needed to build lasting lifestyle changes.

To briefly illustrate how the present method works, let's say that a friend, group of friends an employer, an insurer, or even a government agency (the benefactor) wishes to help the beneficiary lose weight, eat more healthfully, and establish an exercise habit. In this example, the benefactor buys a $200 benefit carrying a six month term for compliance. The purchase, funding, and awareness of this benefit is executed at an Internet business site or through any other well known consumer marketing channel, such as retail stores. This purchase includes defining the acts that the beneficiary must do in order to receive the benefit, and the regimen of such behavior is referred to as “the program.” The program, in this example, specifies that the beneficiary purchase certain healthful grocery items such as fruits and vegetables, skinless chicken breasts, etc. When the beneficiary makes these purchases, a portion of the $200 benefit, is sent to the beneficiary by the program manager. Another portion of the benefit may, for example, be given to the beneficiary each time the beneficiary visits a given health club or gym. By receiving timely rewards spread out over time, the behavior exhibited by the beneficiary is reinforced and this leads to habituation, the forming of desired habitual behavior.

The beneficiary demonstrates the desired behavior by presenting a supermarket or health club loyalty card, or other unique identifier including an identifier that may be issued solely for the purpose of measuring the beneficiary's compliance, at the time of purchase or attendance respectively. Each shopping trip or visit to the gym, for example may only result in a few dollars reward, but a periodically dispersed check resulting from compliance can result in a meaningful monetary stream and thus reinforce additional or improved compliance.

A primary objective inherent in the above described apparatus and method of use is to provide advantages not taught by the prior art.

Another objective is to provide a method that is able to motivate an individual to make lifestyle changes, where the motivation comprises a stream of cash or other benefit delivered to the subject.

A further objective is to provide such a method that is able to be customized so as to be applicable to a wide range of individual situations and personalities, reward frequencies, types, and so on.

A further objective is to provide such a method and system that is automated.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawings is a preferred embodiment of the present invention In such drawings:

FIG. 1 is a matrix showing required behavior and related values of the method of the present invention;

FIG. 2 is a matrix showing actual behavior and dates of the benefit cycle of the method of the present invention;

FIG. 3 is a matrix showing the compliance of actual behavior with the required behavior and the values accumulated there from of the method of the present invention;

FIG. 4 is a matrix of the benefits of the method of the present invention; and

FIG. 5 is an information flow block diagram according to the method of the invention.

### DETAILED DESCRIPTION OF THE INVENTION

The above described drawing figures illustrate the described apparatus and its method of use in a preferred embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and that it should not be taken as a limitation in the scope of the present apparatus and method of use.

The present method is used for motivating a beneficiary, one or more persons or other entities, to establish, continue or habituate a required behavior pattern or patterns, each pattern comprising one or more individual behaviors, and each behavior comprising one or more behavior attributes. To accomplish this, motivation is provided through the delivery of benefit to the beneficiary through a series of benefit events which can be related to behavior. The benefit is preferably given to the beneficiary in small increments as a stream of rewards over time, to reinforce desirable behavior and suppress undesirable behavior.

In its essence, the present method comprising first, the establishment of a contract between the beneficiary and a benefactor, either or both comprising one or more persons or business entities, including nonprofit businesses, governmental organizations and any other formation, club or association. The terms of the contract include, but are not limited to, identifying the benefactor, the beneficiary, the required behavior, a benefit matrix, a benefit cycle, and an identified contract termination, by date, by a selected event, or by other clearly defined element. The termination date may be a chosen date, one month or one year in the future, for instance, and the selected termination event may be a loss of 35 pounds of body weight, the achievement of a grade in a particular school course, as just one example. Clearly, the contract may comprise other terms as well. The benefit cycle is the fixed period of time between calculations of, and distributions of the benefit.

Preferably, at least one of the terms of the contract is established by the benefactor or the beneficiary alone, or through negotiation by the benefactor and beneficiary. Preferably the entire contract is the product of both the parties so that there is complete agreement prior to starting the program. Preferably, subsequent to establishing the terms of the contract, renegotiation of its terms may be negotiated by the parties when it is clear that either the terms of the contract are not viable to one or both parties, or the program manager is requests a change.

Furthermore, the present method requires communicating the terms of the contract to the beneficiary, assuming the beneficiary has already agreed to be involved, or obtaining the beneficiary's agreement to participate in the contract, if not. Since this method requires ongoing control a program manager is preferably enlisted and a required behavior matrix is established as will be described below.

The present method establishes the monitoring of the actual behavior of the beneficiary thereby establishing an actual behavior matrix, and intersecting the actual behavior matrix with the required behavior matrix enables the generation of a compliance matrix.

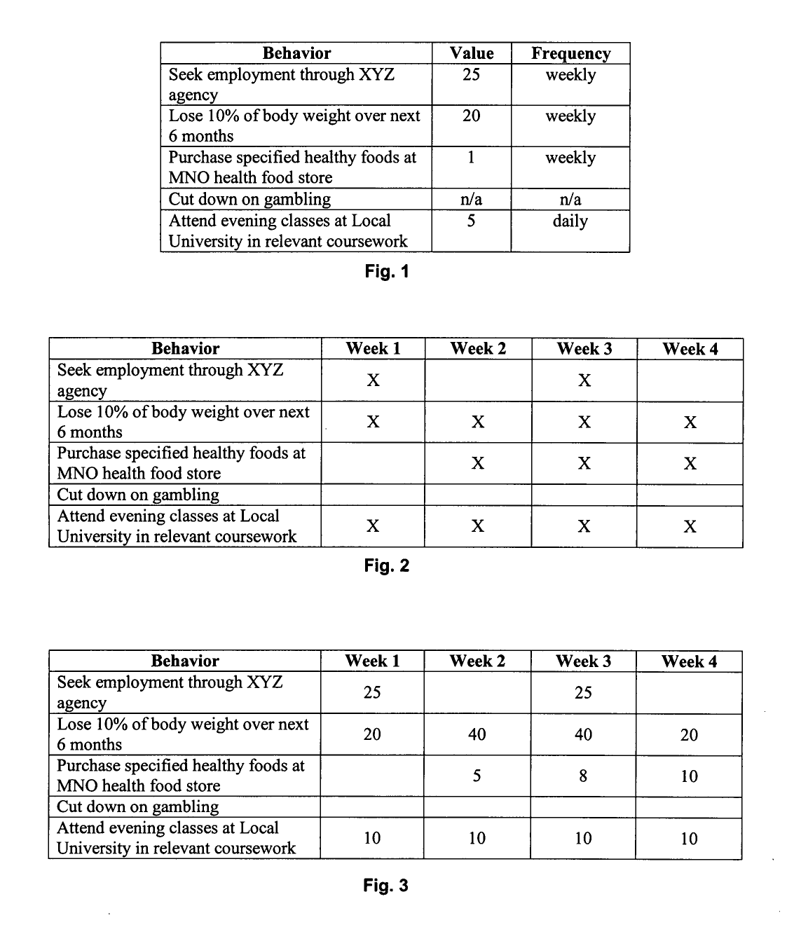

The required behavior matrix, see FIG. 1, may be conceived as a list arranged as a single column of separate items, each a required behavior attribute according to the contract. For instance, the required behavior may be “improve diet” and behavior attributes of this behavior may be: purchase fruits and vegetables, cut down on restaurant dining, and lower cholesterol. Next to each behavior attribute is a weighted level of importance or value forming a second column. Next to each element of the second column is a third column with a notation indicating frequency of expectation, that is, how often the behavior attribute is expected to occur or be measured.

The actual behavior matrix, see FIG. 2, may be conceived as similar to the required behavior matrix. Here, a set of columns are similarly provided including a copy of the behavior attribute column and further including a plurality of date columns arranged in accordance with the frequency of expectation provided by the required behavior matrix. The date columns are identified by date of expectation at the top of each column, but the cells of the date columns are empty at the start of the program. These cells are filled in accordance with when behavior events occur and are recorded.

The compliance matrix, see FIG. 3, may be conceived as similar to FIG. 2 with a copy of the behavior attribute column and further including a plurality of the date columns each headed by the same dates as in FIG. 2.

As an actual behavior is recorded, a cell in a date column in FIG. 2 is filled indicating that the specific behavior occurred on a specific date. Next, FIG. 3 is filled in by cross-referencing the information that the specific behavior occurred, as taken from the corresponding cell in FIG. 2, with the information that the specific behavior carries a value taken from FIG. 1. Therefore, the date cells of FIG. 3 are filled in with the values from FIG. 1.

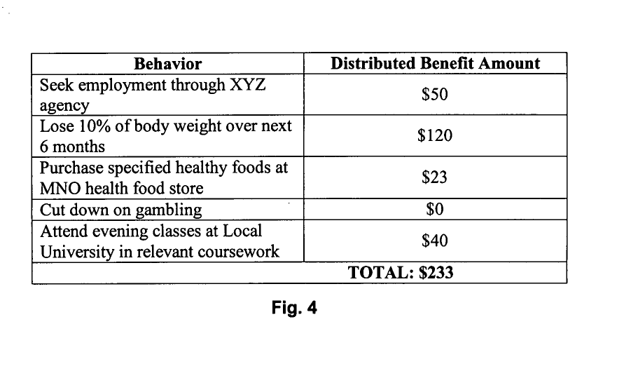

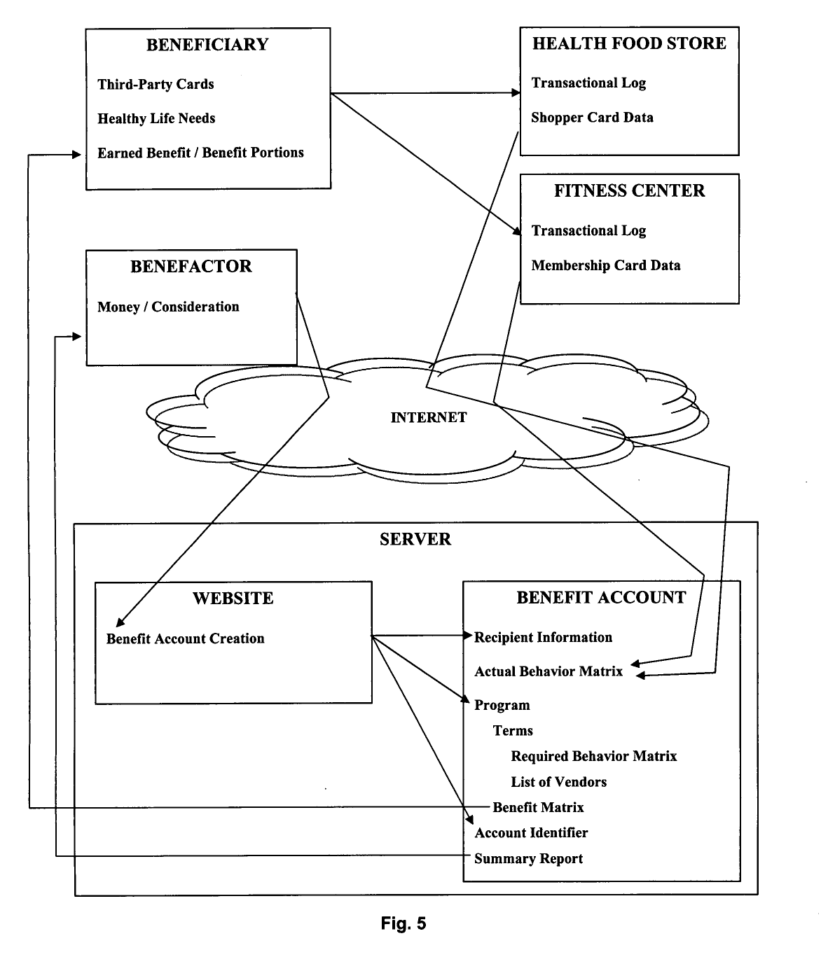

At the end of each benefit cycle of the program, daily, weekly, bi-weekly, monthly, and so on, the intersection of the compliance matrix of FIG. 3, and the benefit matrix of FIG. 4 is compiled and stored. This determines the type and the amount of benefit to be distributed to the beneficiary. The program manager then delivers the benefit to the beneficiary.

In the above description of program operation, matrices are used as exemplars of the steps in the program so that the reader can visualize the manner in which the program proceeds. However, in the preferred embodiment, the recording, compiling and evaluation of results are executed by an automated digital processor such as a microcomputer which is referred to herein as a “server.”

The method described in above continues in repetitive cycles of monitoring behavior, comparing behavior, establishing compliance, and bestowing benefit until the objective is accomplished, the benefit account is depleted or closed, it is determined that the compliance is unacceptable and the contract is voided, or the contract termination occurs.

Preferably, when the benefit account is closed prior to both the benefit account being depleted and the contract terminated, the balance in the benefit account is distributed to at least one of: the benefactor, the beneficiary and the program manager.

Preferably, one or more of the terms of the contract are established by means of a beneficiary testing instrument such as an actual testing of the beneficiary to determine one or more of his/her attributes, aptitudes, attitudes or weaknesses. Alternatives include compiling information about the beneficiary from third party sources.

Preferably, monitoring the actual behavior of the beneficiary is done using a personal identifier such as a membership card, a loyalty card, a reward card, a credit card, an insurance card, an account number, an RFID chip, or a biometric identifying enablement, all of which are well known in the art.

Once the behavior of the beneficiary is recorded, preferably, more or less automatically, an automatic comparison of the actual behavior matrix with the required behavior matrix compiled by the server, and is preferably then reported to the beneficiary and the benefactor. The method provides for taking the step of enabling at least one of the beneficiary and the benefactor to adjust the benefit matrix based on reported results. The method also includes provision for reversing, forfeiting or loosing benefits when the reports show that the actual behavior is moving counter to the required behavior.

Clearly, in some cases, the required behavior should not remain static, that is, consistent over time, but rather the bar should be raised from time to time to stretch the beneficiary. Examples of this may include grades in school, abilities in the gym and so on.

Once the benefit account is either depleted or closed, or the compliance matrix is deemed to be unacceptable, or the contract termination occurs, the step of compiling a final results report of overall behavior change of the beneficiary is produced and distributed to the parties.

In the present method, the beneficiary and the benefactor may be the same person, when that person needs an outside motivating force other than his/her own willpower. The beneficiary may be a group of individuals, such as a family or a sports team. The benefit may be money, or any other consideration such as airline mileage points or entries into a sweepstakes. The contract must specify in detail the behavior required including how and when behavior is to be performed. It also must specify the method of dispersing the benefit and the amount of the benefit that will be dispersed for each specific behavior. Also, a minimum level of acceptable compliance is specified below which the contract must be cancelled.

The program manager provides the operational support required to measure and confirm compliance with the program. In the preferred embodiment, the manager utilizes the server to operate as a central account management point. In the preferred embodiment, the server communicates with the beneficiary, the benefactor and vendors through the Internet. The server provides the benefactor with the ability to establish a reward account, identify the beneficiary, detail the proposed behavior program, bring vendors into the program, set the value of benefit disbursements relative to beneficiary behavior, establish terms of the contract, forward the contract to the beneficiary, and assign a unique account identifier to the beneficiary.

The vendors are independent third parties such as commercial providers of products or services including grocers, health clubs and gyms, educational services, employment placement services, public transportation services, and so on. When the benefactor establishes a reward account and defines the behavior, the benefactor has the ability to choose from a list of participating vendors. For example, the benefactor may require that the beneficiary exercise at a particular gym or shop at a particular health food store. In an alternate embodiment, participating vendors are automatically selected by the server based on the behavior requirements, location of the beneficiary and other factors.

Once a list of approved vendors is defined and incorporated into the program, the server establishes relationships with each one of the vendors with regard to the beneficiary. When these links are established, behavior data is sent from each one of the vendors to the server each time the beneficiary interacts with the vendors, or on a set periodic basis. Alternatively, the server is able to acquire behavior data from third party data collection agencies, such as Sallie Mae, Nielsen, Information Resources, Inc. or Catalina. When this is done, the benefactor is required to provide the server with an identifier such as a supermarket loyalty card number, credit card number, or other third-party card which enables the server to link actual behavior 8 with the corresponding reward account.

Actual behavior consistent with the program is tracked and confirmed in a variety of ways, but all involve one or more identifiers; that is, unique numbers which, as mentioned above, might be found on a third-party card, such as a supermarket loyalty card or credit card, the numbers being associated with the beneficiary. The identifiers may appear in the transactional logs of affiliated vendors, in the data collected by point-of-sales systems and/or attendance/use measurement systems at health clubs, on buses or trains and schools and the like, from specific pieces of exercise equipment, or from the electronic logs kept by most automobiles regarding the drivers speed and miles driven. When an identifier associated with the beneficiary is associated also with an actual behavior, for instance by virtue of a qualified purchase or transaction, this behavior data is sent to the server, as described above.

The server receives behavior data from vendors based on actual behavior demonstrated by the beneficiary, associates it with the appropriate reward account and checks it against the program for that particular reward account in order to determine compliance. Compliance means acting in accordance with the defined behaviors enumerated by the program. In other words, if one of the defined behaviors requires the beneficiary to exercise at a local gym, and the beneficiary actually goes to the local gym to exercise, his actual behavior will be in compliance with the program.

As mentioned above, the benefactor has the option of specifying a minimum level of acceptable compliance. Thus, if the beneficiary fails to stay above that minimum level of compliance, i.e., if compliance becomes “unacceptable,” the contract can be canceled by the benefactor. Such minimum levels of acceptable compliance could, for example, include a requirement that the beneficiary comply with a defined behavior to exercise at least once a week. If the beneficiary fails to exercise at the gym during a given week, this would constitute “unacceptable” compliance and could be grounds for terminating the program. If the benefit account is not fully depleted when the program is terminated the remaining balance may, in part, be transferred to the program manager.

The benefit may be dispersed in a number of ways including, but not limited to, being mailed as a check, direct deposit to a bank account, as a credit to a credit card account, as a line item on a paycheck, etc. The benefit earned might also be deposited into deferred accounts such as a 401K plan, an IRA, or a 529 Education Savings plans. The benefit can be parceled periodically, or as a lump sum. In addition, the benefit can be dispersed in level increments, i.e., the same sized reward portion in return for behavior regardless of when or how often it occurs, or it can be scaled to the frequency of the behavior. Benefits can also be negated when the beneficiary performs an undesirable act such as visiting a gambling casino.

In an alternate embodiment, the beneficiary is given a reward card which contains the account identifier in order to link actual behavior with the reward account. The reward card provides a magnetic stripe, similar to that of a credit or debit card, and is able to receive and store information regarding the actual behavior. However, other types of cards capable of holding information may be substituted in this application. Each time the beneficiary exhibits an actual behavior, the beneficiary has an opportunity to swipe the reward card using a card terminal located at the vendor's place of business. When a reward card is swiped, the card terminal writes a credit to the reward card. The beneficiary may upload these credit to the server at any time by swiping the reward card through a card terminal that is in communication with the server. When the credits are received, the server processes a distribution of the benefit to the beneficiary accordingly.

In the following example a hypothetical beneficiary is a young man who may be described as: unemployed, overweight, has poor eating habits, is a chronic gambler, and has dropped out of school and is seriously in need of money. The benefactor is the beneficiary's family: father, mother, a sister and two brothers. Together, they have a strong interest in seeing the beneficiary change his lifestyle. In this example, the benefactor establishes a benefit program with a benefit valued at $1,000 with a six month term, and specifies the defined behaviors as specific measurable items, collectively known as the program, as follows:
a. Seek employment through the XYZ agency, verifiable by the agency when the beneficiary follows up on provided employment leads at $25 per lead.
b. Lose 10% of body weight over the next six months, verifiable by weekly weight measurements taken at the ABC exercise salon at $20 per point.
c. Purchase healthy foods at MNO health food store according to a list provided at $1 per item.
d. Cut down on gambling habit (not tracked).
e. Attend evening classes at Local University in relevant coursework at $5 per class attended.

It is estimated that if the beneficiary takes a proactive approach to all five defined behaviors, he can earn and receive the entire $1,000 reward over the six month time period of the contract. Although behavior (d) is not tracked, it is assumed that if the other items are actively completed, then little time or motivation will be left for behavior (d). Behavior (d) is included here to illustrate that not all current actual behaviors of a beneficiary are able to be tracked, and many may not be extinguished using the present invention method, but there might also be the addition of punishments such that the use of the beneficiary's credit card at the local horse track or casino negates reward portions he may have earned over the prior week. To continue with the present example, the server communicates with the beneficiary informing him of the terms and that if the $1,000 reward is not fully depleted before the six month deadline, the unused remaining balance becomes the property of the program manager. This may be a motivator in itself, in that the beneficiary does not want to see his family's money wasted. The server establishes a relationship with the XYZ agency, the ABC health club, MNO health food store, and a local university so that the beneficiary's activities with these vendors are able to be documented and compliance with the program can be confirmed. In accordance with the terms of the program, payments are distributed to the beneficiary on a weekly basis in accordance with the specified wishes of the benefactor. This provides a motive for changing the beneficiary's lifestyle and releases a stream of benefit as lifestyle goals are being met.

As previously mentioned, the present invention method is preferably carried out using a high-speed digital processor; the server in the present method. The information acquired from the vendors of the method is easily placed into the actual behavior matrix by wired or wireless communication from card swiping devices to the server. The taking of the intersection of matrices is easily carried out by such high-speed processors as well. When the intersection of the compliance matrix and the benefit matrix is carried out, the server may very well be enabled to communicate with the financial institute where the benefit account is held, requesting a transfer of funds into the beneficiary's bank account. This can take place at the end of each benefit cycle according to the terms of the contract and may be fully automated as described.

The enablements described in detail above are considered novel over the prior art of record and are considered critical to the operation of at least one aspect of the present method of use and to the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. A method of motivating a beneficiary to establish, continue or habituate a required behavior, the method comprising the steps of:
a) establishing terms of a contract including: a benefactor, the beneficiary, a required behavior matrix, a benefit matrix, a benefit cycle, and a contract termination;
b) communicating the terms of the contract to the beneficiary;
c) monitoring actual behavior of the beneficiary to form an actual behavior matrix;
d) forming a compliance matrix as the intersection of the actual behavior matrix with the required behavior matrix;
e) bestowing a benefit from a benefit account onto the beneficiary in accordance with, the benefit cycle and the intersection of the compliance matrix and the benefit matrix; and
f) repeating steps (c), (d) and (e) for each benefit cycle until at least one of:
1. the benefit account is depleted;
2. the benefit account is closed;
3. the compliance pattern is unacceptable; and
4. the contract termination occurs.

2. The method of claim 1 comprising the further step of establishing at least one of the terms of the contract by at least one of the benefactor and the beneficiary.

3. The method of claim 1 comprising the further step, prior to establishing the terms of the contract, of negotiating at least one of the terms of the contract between the benefactor and the beneficiary.

4. The method of claim 1 comprising the further step, subsequent to establishing the terms of the contract, of renegotiating the terms of the contract between at least two of: the benefactor, the beneficiary and a program manager.

5. The method of claim 1 comprising the further step, when the benefit account is closed prior to both the benefit account being depleted and the contract terminated, of distributing a balance in the benefit account to at least one of: the benefactor, the beneficiary and a program manager.

6. The method of claim 1 comprising the further step of establishing at least one of the terms of the contract by means of at least one of: testing the beneficiary to create a testing instrument; a compiling information about and from the beneficiary to create an information instrument; and compiling information about the beneficiary from at least one third party to create the information instrument.

7. The method of claim 1 wherein the steps of monitoring the actual behavior of the beneficiary is conducted by at least one third party.

8. The method of claim 7 further comprising the step of employing a commercial provider of goods or services as one third party.

9. The method of claim 7 further comprising the step of employing a commercial financial institution as one third party.

10. The method of claim 1 further comprising the step of using a personal identifier in monitoring the actual behavior of the beneficiary.

11. The method of claim 10 wherein the personal identifier is at least one of: a membership card, a loyalty card, a reward card, a credit card, an insurance card, an account number, an RFID chip, and a biometric identifying enablement.

12. The method of claim 1 further comprising the step of reporting at least one of the actual behavior matrix, the required behavior matrix and the compliance matrix to at least one of the beneficiary and the benefactor.

13. The method of claim 12 further comprising the step of enabling at least one of the beneficiary and the benefactor to adjust the benefit matrix.

14. The method of claim 12 further comprising the step of including in the terms of the contract, provision for reversing, forfeiting or loosing the benefits to the beneficiary depending on the compliance matrix.

15. The method of claim 12 further comprising the step of compiling a final results report of overall behavior change of the beneficiary when at least one of:
1. the benefit account is depleted;
2. the benefit account is closed;
3. the compliance pattern is unacceptable; and
4. the contract termination occurs.
